(19) United States
(12) Patent Application Publication
(10) Pub. No.: US 2024/0378023 A1
(43) Pub. Date: Nov. 14, 2024

(54) METHOD FOR QUALITY ASSURANCE OF A SYSTEM

(71) Applicant: Siemens Mobility GmbH, München (DE)

(72) Inventor: Thomas Waschulzik, Freising (DE)

(21) Appl. No.: 18/564,174

(22) PCT Filed: May 3, 2022
(86) PCT No.: PCT/EP2022/061830

§ 371 Date: Nov. 27, 2023

(30) Foreign Application Priority Data
May 26, 2021 (DE) 10 2021 205 339.4
Jul. 16, 2021 (DE) 10 2021 207 613.0

(51) Int. Cl. G06F 8/10; G06N 3/045; G06N 3/084

(52) U.S. Cl. CPC G06F 8/10; G06N 3/045; G06N 3/084

(57) ABSTRACT

A method for quality assurance of a system, which includes an example-based sub-system. In order to improve the quality assurance of the system, the method involves the example-based sub-system being created and trained on the basis of collected examples that form a set of examples. The quality assurance of the system is carried out based on a procedure model for carrying out a development process representing a plan for proceeding during the quality assurance of the system. The quality assurance of the example-based sub-system is carried out based on a quality assessment which is determined based on the set of examples.

The invention relates to a method for quality assurance of a system which has an example-based subsystem.

Systems which are used for safety-oriented applications are basically known. These systems can have example-based subsystems.

Example-based systems, such as artificial neural networks, are basically known. As a rule, they are used in fields in which a direct algorithmic solution does not exist or cannot be created adequately with conventional software methods. By means of example-based systems, it is possible to create and track a task on the basis of a set of examples. The learned task can be applied to a set of further examples.

The dissertation “Qualitätsgesicherte effiziente Entwicklung vorwärtsgerichteter künstlicher Neuronaler Netze mit überwachten Lernen (QUEEN)” [Quality-assured Efficient Development of Forward-directed Artificial Neural Networks with Supervised Learning] by Thomas Waschulzik describes the development of forward-directed artificial neural networks with supervised learning (hereinafter: WASCHULZIK).

Against this background, it is an object of the invention to improve the quality assurance of a system which has an example-based subsystem.

This object is inventively achieved by a method for quality assurance of a system which has an example-based subsystem. In the inventive method, the example-based subsystem is created and trained on the basis of collected examples which form an example set. The quality assurance of the system takes place on the basis of a procedure model which represents a plan for the procedure in the quality assurance of the system. The quality assurance of the example-based subsystem takes place on the basis of a quality evaluation which is ascertained on the basis of the example set.

On the one hand, the invention is based on the finding that example-based subsystems, such as neural networks, are often regarded as a black box. In this case, internal information processing is not analyzed and generation of an understandable model is omitted. In addition, the subsystem is not verified by an inspection. This results in reservations in the use of example-based subsystems in high-criticality tasks.

The invention is also based on the finding that, when acquiring examples for the creation and training of the example-based subsystem, it is frequently unknown how many examples have to be acquired and in which regions of the input space in order to create a suitable knowledge base.

A further essential finding of the invention is that the use of example-based subsystems for safety-oriented applications is desirable and is currently being advanced with great success. Since the quality assurance of the created system is not satisfactorily ensured, some of these systems cannot be permitted for application.

The inventive solution rectifies these problems in that quality assurance of the system takes place on the basis of a procedure model which represents a plan for the procedure in the quality assurance of the system, and the quality assurance of the example-based subsystem takes place on the basis of a quality evaluation, which is ascertained on the basis of the example set. The quality assurance of the system on the basis of the procedure model is expediently supplemented by the quality assurance of the example-based subsystem on the basis of the quality evaluation in such a way that the system can be used for safety-oriented applications. In other words: the quality evaluation is used to ensure the quality of the example-based portion of the overall system.

Preferably, the example-based subsystem is provided for use in a safety-oriented function of the system. A person skilled in the art understands the term “safety-oriented function” as a function of a system which is relevant to safety, that is to say, its behavior has an influence on the safety of the environment of the system. The term “safety” should be understood in terms of what is referred to as safety. In the language of experts, “safety” denotes the aim of protecting the environment of a system against hazards which originate from the system. In contrast, in the language of experts, the aim of protecting the system from hazards originating from the environment of the system is referred to as “security”.

According to a preferred embodiment of the inventive method, the respective example of the example set comprises an input value which lies in an input space. The local environment of an example in the input space is used for a decision about the application of the example-based subsystem or the control of the development process.

The local environment is preferably the surrounding area of the example in the input space, which has a predefined distance from the example, which is less than a defined distance value.

In a preferred development of the embodiment, a weighting for the application of a plurality of example-based subsystems is dependent on the density of the examples in a local environment of the input space of an example.

In this way, a plurality of subsystems (knowledge bases) is suitably combined by weighting. The following example is intended to illustrate this idea: a first example-based subsystem is used to identify objects on the basis of items of image information from an infrared camera. A second example-based subsystem serves to identify objects on the basis of items of image information from a camera in the visible range. These two subsystems can be combined with one another in such a way that the first subsystem receives a greater weighting than the second subsystem at night. In this case, it should be taken into account that an example has a plurality of features. The example is represented by a specific characteristic of a feature vector. A single entry of the feature vector is an example feature which represents a property of an example. In the case of the creation of example-based subsystems (knowledge bases), modularization is accordingly possible in which a subset of the features of an example is used for the creation of one of the plurality of example-based subsystems (knowledge bases). A further subset of the features is used, for example, for the creation of a further subsystem of the plurality of example-based subsystems. With regard to the example illustrated above (identification of objects on the basis of items of image information), a first subset of the features can originate from the infrared camera and a second subset of the features from the camera in the visible range. During the day, the features of the second subset are used for the creation of the subsystem. At night, a combination of the first and second subsets is used for the creation of the further subsystem.

In a further preferred development of the embodiment, the decision about the selection of the application of an example-based subsystem is made from a plurality of alternative example-based subsystems.

The selection of the application of an example-based subsystem from a plurality of example-based subsystems is preferably to be understood as a special case of weighting: if one of two subsystems is selected, this selected subsystem receives the weighting 1 and the non-selected subsystem receives the weighting 0.

According to a further preferred development of the embodiment, the decision is made that an example-based subsystem is not applied if the number of examples which is present in the local environment of the example is smaller than a predefined value. In other words: an example-based subsystem is applied if the number of examples which lie in the local environment of the example is greater than a predefined value.

According to a further preferred development of the embodiment, a process parameter, which represents the trustworthiness of the competence of the example-based subsystem, is set as a function of the local environment of the example.

In this way, an evaluation of the trustworthiness of the output of the example-based subsystem is made possible. For example, a high competency of the example-based subsystem can be assumed if the local environment of the example comprises a large number of examples.

According to a particularly preferred embodiment of the inventive method, the respective example comprises an output value which lies in an output space. A local complexity evaluation, which represents a complexity of a task of the example-based system, defined by the examples of the surrounding area, is ascertained for the respective surrounding area. The local complexity evaluation is determined by the relative position of the examples of the surrounding area with respect to one another in the input space and output space.

The person skilled in the art understands the wording “relative position of the examples of the surrounding area with respect to one another in the input space and output space” preferably such that the complexity evaluation is defined on the basis of the consideration of the similarity of the distances of the examples in the input space to the distances in the output space. For example, the task of the example-based system has a comparatively low complexity if the distances in the input space (aside from the scaling) approximately correspond to the distances in the output space.

This results in the advantage that examples can be effectively acquired. This is because regions are known on the basis of the complexity evaluation in which, due to the high complexity of the task of the example-based system, a comparatively high number of examples has to be acquired.

The complexity evaluation corresponds, for example, to the quality indicators described in Section 4 (QUEEN quality indicators) by WASCHULZIK. These quality indicators can be defined and applied for the representation or encoding of the features (cf. section 4.5 of WASCHULZIK).

The process parameter, which represents the trustworthiness of the competence of the example-based subsystem, is preferably determined not only as a function of the local environment of the example, but also as a function of the local complexity evaluation. For example, a high competence of the example-based subsystem is to be assumed if the local environment of the example comprises a large number of examples and the local complexity is simultaneously low.

Because different example-based subsystems use different features for learning a mapping, different dimensions of the input space and thus also different complexities in the local environment of the input space can result accordingly for different example-based subsystems.

According to a further preferred embodiment of the inventive method, a complexity distribution is ascertained by means of a histogram representation of the complexity evaluation.

Preferably, the value range of the complexity evaluations is binned for the histogram representation (that is to say, divided into regions). In a preferred development, the complexity distribution over k nearest neighbors of an example is ascertained in the input space. In this way, it is ascertained how the complexity is distributed for the local environment of an example. In particular, the characteristic of the complexity in the local environment of the example is ascertained and, as it were, a fingerprint of the local environment of the example is ascertained in respect of the complexity. If the number of examples in the region under consideration is increased (that is to say, examples are added), this can result in the effect of an automatic adaptation of the region under consideration in the input space. By increasing the available number of examples in a critical region of the input space, the complexity is reduced in the local environment of the examples. One reason for this is that-if this is a functional relationship-more examples can then be found in the environment in the input space which have a similar output.

In the case of a classification task in which a plurality of regions is divided into different classes, the boundaries between the classes can be more clearly defined thereby. If the local complexity does not reduce despite the increase in the number of examples, a range is found in which the features used do not allow separation of the classes. As a result, an indication is obtained that it is necessary to search for more suitable features for the separation of the classes or to achieve the task in another subsystem. In this respect, the decision about the acquisition of further examples is made across all subsystems. For example, the “binned” values are plotted on the y-axis and the representation of the increasingly large k (the k-nearest neighbor) is entered on the x-axis.

The step size of the values of k>1 is selected in order to reduce the required computing capacity when ascertaining the complexity distribution. For example, a distribution of the complexity evaluation is ascertained at a step size of for the values of k=5, 10, 15, 20, etc., More preferably, the step width of k is selected to be small exclusively in regions of particular interest. Thus, for example, the distribution of the complexity evaluation is first calculated with a comparatively large step size of k in order to then be calculated in a region of particular interest with a small step size of k.

More preferably, the number of values of the complexity evaluation is stored for the calculated histogram field (complexity evaluation binned, k). More preferably, an item of identification information (for example a number) is also preferably stored, which [ ] the example in whose environment the complexity distribution was ascertained.

According to a preferred development of the embodiment, the decision is made that an example-based subsystem is not applied, because the complexity evaluation in the local environment of the input space for the required quality of the application of the example-based subsystem is greater than a predefined value.

Preferably, in the decision to not apply an example-based subsystem, either another subsystem is applied or a safe state is assumed by the overall system.

In a further preferred development of the embodiment, the weighting for the application of a set of example sets is made as a function of the local complexity in the local environment of the input space.

In a further preferred development, the decision is made on the basis of a certain number of nearest neighbors to an example, the number of examples which are situated at a defined standardized distance from the example under consideration and/or a quality indicator in a subspace of the input space, which is determined for a relevant subset of the subspaces of the input space.

The above-described criteria are preferably meaningfully combined with one another for the decision.

Relevant subspaces of the input space can be, for example, all subspaces of the input space defined by a criterion, or all subspaces for which a sufficient number of examples is available or which are relevant to the application owing to other criteria.

Examples of a criterion are mentioned below:
There are fewer than m examples at a smaller distance than z to the example under consideration.
The mean distance of the next m examples is less than z.
The complexity of the mapping described by the m next neighbors is greater than w.
The complexity of the examples at a standardized distance smaller than d is less than the value r of the quality indicator Q.

The standardization of the distance can be determined on the basis of the examples previously acquired (see, for example, the calculation of the standardized distance in QI²).

One particular characteristic is the determination of the local complexity on the basis of the validity indicators defined in WASCHULZIK.

In a preferred embodiment of the inventive method, ascertaining the quality evaluation comprises: distributing representatives in the input space and assigning a number of examples of the example set to the respective representative. The examples assigned to the representative are in a surrounding area of the input space which surrounds the representative. A local quality evaluation for the surrounding area is ascertained as the quality evaluation.

By assigning the examples from the example set to the representatives, example data sets are determined within the surrounding areas, which are assigned to the representatives. The local quality evaluations respectively are calculated for these example data sets.

The division of the example set into a plurality of surrounding areas involves the advantages which result from the approach of the divide and conquer method which is known from computer science. Thus, for example, a development of the example-based system or a computer program for quality assurance can concentrate on those parts of the input space in which particular quality criteria are not met by the ascertained quality evaluation. The quality can be checked accordingly and possibly improved in these parts. As a result, the effort in the evaluation of the overall example set is considerably reduced.

The representative is preferably a proxy example. The distribution is preferably a uniform distribution. A grid for arranging the proxy examples is selected in the input space, for example. The grid can be individually defined for each dimension of the input space. A criterion for the definition of the grid, for example in the case of quantitative variables, can be a model of target properties of the example distribution in the input space, which is provided on the basis of the demands on the example-based system. The grid can be structured hierarchically in order, for example, to map hierarchical encodings. When applying a grid for the arrangement of the proxy examples, one or more proxy example(s) is/are distributed in each hypercube in the input space of the grid. In the case of a hierarchical structure of the grid, one proxy example is distributed per hierarchy level.

Alternatively, the representative is a center of a cluster which is determined by means of a cluster method. The cluster method is preferably used to determine the position and to determine the extent of the respective cluster in the input space. More preferably, the cluster method is carried out by taking into account output values of the examples which lie in an output space. The clusters can be defined on the basis of demands on the properties of the exampled-based system or on the basis of a subset of example data. In the application of the example-based system, for example in an early phase, a set of examples can be acquired which is selected on the basis of knowledge for fulfilling the demands. This distribution of the example data is then quality-assured. In a following project phase, further examples with the same distribution can be acquired. In this case, each example of the quality-assured example set represents a representative for the following phase of acquisition of the examples. This ensures that an additional quality-assured set of examples is acquired for each initial example. The position of the representative can be defined, for example, by the cluster center. Alternatively, a hierarchical cluster method can be used in which one representative is inserted per cluster and per hierarchy level and in which each example per hierarchy level is assigned to a cluster and consequently to a representative. The set of examples, which is available for the calculation of the quality evaluation, is subsequently assigned to the clusters and consequently to the representative via a predefined metric. For an example which cannot be assigned to a cluster, a new cluster is preferably created with a representative. Alternatively, this example, together with further examples which could not be assigned to a cluster, is acquired separately by way of a quality evaluation.

More preferably, the examples are not completely assigned to a representative but only to a predefined portion. This can result, for example, in a cluster algorithm being used which supplies a partial assignment of the examples to the example data sets (for example, a percentage assignment to a plurality of surrounding areas, with the sum of the portions being 1). When ascertaining the quality evaluations on the basis of this partial assignment, the respective example is taken into account in accordance with the associated portion.

The quality evaluation is preferably ascertained on the basis of the number of examples assigned to the respective representative or on the basis of other features. This is particularly advantageous if the specific examples are subsequently no longer used. Alternatively or in addition, the specific examples or a reference to the examples in the representative (transformation of the example data set into a structure oriented to the topography of the input space) is/are stored. This is advantageous if the specific examples are subsequently required.

The organization, processing, and storage of a large number of the above-described representatives frequently constitutes a challenge, and this concerns existing storage and computing capacities. The publication “AN IMPLEMENTATION OF A MULTIDIMENSIONAL DYNAMIC RANGE TREE BASED ON AN AVL TREE” by Michael G La-moureux (TR95-100, November 1995) (retrievable at: https://11 www.cs.unb.ca/tech-reports/documents/TR95_100.pdf) describes an exemplary implementation for storing the representatives. The representatives are accessed with a complexity of the order O (log (N)), where N is the number of representatives.

Alternatively, the storage of the representatives can be implemented by balanced trees, such as B-trees (https://de.wikipedia.org/wiki/B-Baum) or R-trees (https://de.wikipedia.org/wiki/R-Baum) or generalized search trees (Https://en.wikipedia.org/wiki/GiST).

The memory space required for processing is more preferably reduced by only storing the representations when at least one example is in the respective surrounding area. If the coverage of the input space is ascertained, the surrounding areas in which no representative was created are evaluated as “no example present”. Nevertheless, a histogram about the number of examples per representative can be created since the number of surrounding areas in which no example was acquired can be determined with little effort (sum of the expected representatives—created representatives=number of fields without acquired examples).

Preferably, the density of the representatives is dynamically increased in regions of the input space in which a higher complexity is present until a homogeneous complexity is achieved and a sufficient set of examples is in the environment of the representatives.

According to a further preferred embodiment of the inventive method, the quality evaluation comprises a statistical mean which, on the basis of the local environment and/or on the basis of the representative of the type described above, to which the example under consideration is assigned in accordance with its position in the input space.

In this way, on the basis of the items of information assigned to the representatives, quality evaluations can be defined, for example, with means of descriptive statistics (as described in one of the following textbooks: “Statistik: Der Weg zur Datenanalyse” [Statistics: The Path to Data Analysis] (Springer-Lehrbuch) Taschenbuch—15 Sep. 2016 by Ludwig Fahrmeir (author), Christian Heumann (author), Rita Künstler (author), Iris Pigeot (author), Gerhard Tutz (author); “Statistik für Dummies” [Statistics for Dummies] Taschenbuch—4 Dec. 2019 by Deborah J Rumsey (author), Beate Majetchak (translator), Reinhard Engel (translator); “Arbeitsbuch zur deskriptiven und induktiven Statistik” [Work Book for Descriptive and Inductive Statistics]” (Springer-Lehrbuch) Taschenbuch 27. February 2009 by Helge Toutenburg (author), Michael Schomaker (contributor), Malte Wissmann (contributor), Christian Heumann (contributor).

In a preferred development, a histogram about the number of examples assigned to a representative is created as a statistical mean.

As a result, a particularly simple and intuitive possibility for evaluating and representing the coverage of the input space is achieved.

The person skilled in the art will preferably understand the wording “about the number of examples assigned to a representative” such that the values of the number of examples assigned to a representative are binned (that is to say, divided into regions) for the creation of the histogram.

According to a further preferred development, a statistical measure, in particular an average value, a median, minimum, maximum and/or quantile of the number of examples assigned to a representative is ascertained as a statistical mean.

According to a preferred embodiment of the inventive method, the integrated quality indicator QI² according to section 4.6 of WASCHULZIK is used as a quality indicator for the representations, and this can be defined on the basis of formula 4.21 as follows:

$${QI}^{2} ( P ) = \frac{1}{\vert {P}^{2} \vert} {\sum }_{{x}_{i} ∈ {P}^{2}} {( {d}_{NRE} ( {x}_{i} ) - {d}_{NRA} ( {x}_{i} ) )}^{2}$$

where according to Formula 4.18 of WASCHULZIK:

$${d}_{NRE} ( x ) = {d}_{RE} ( x ) / \frac{{\sum }_{y ∈ {P}^{2}} {d}_{RE} ( y )}{\vert {P}^{2} \vert}$$

is the standardized distance of the represented inputs (NRE) and

$${d}_{NRA} ( x ) = {d}_{RA} ( x ) / \frac{{\sum }_{y ∈ {P}^{2}} {d}_{RA} ( y )}{\vert {P}^{2} \vert}$$

is the standardized distance of the represented outputs

(NRA). In this case, x is the pair (x₁,x₂,) consisting of the two examples x₁ and x₂. x₁ and x₂ are examples from the example set P·P={p₁, p₁, . . . , p_{|P|}} is the set of the elements of BAG P, where |P²| is the number of elements of BAG P. BAG is a multiset (in English, multiset or bag) as defined in specification 21.5 on page 27 of the Appendix by WASCHULZIK. The task QAG is defined in definition 3.1 on page 23 of WASCHULZIK and is referred to there as a QUEEN task.

d_{RE}(x) is an abbreviation for the distance in the input space dᵣₑ(vepₓ₁, vepₓ₂) and d_{RA}(x) is an abbreviation for the distance in the output space (dᵣₐ(vapₓ₁, vapₓ₂).

The definition of the distance between the representation of two examples according to WASCHULZIK is based, for example, on the Euclidean norm. Thus, the distance in the input space is defined as (see formula 4.3 of WASCHULZIK):

$${d}_{re} ( {p}_{k 1} , {p}_{k 2} ) = \sqrt{{\sum }_{i = 1}^{aem} {( {vemp}_{i , k 1} - {vemp}_{i , k 2} )}^{2}}$$

with pₖ₁, pₖ₂ as examples from the set P, where

$${p}_{k} = ( {vep}_{k} , {vap}_{k} ) = ( \begin{matrix}( {vemp}_{1 , k} , {vemp}_{2 , k} , ... , {vemp}_{NumberInputFeatures , k} ) , \\ ( {vamp}_{1 , k} , {vamp}_{2 , k} , ... , {vemp}_{NumberInputFeatures , k} )\end{matrix} )$$

where
i Index across all characteristics;
vemp_{i,kx} Characteristic of the input feature i of the example kx mit kx∈R (R is the set of real numbers); and
aem NumberInputFeatures of the task QAG.

The person skilled in the art will understand the wording “on the basis of the following definition” or “can be defined on the basis of Formula 4.21 as follows” preferably such that modifications and a function of the quality indicator F (QI²) are also encompassed by the idea of this definition.

More preferably, an aggregated complexity evaluation is ascertained by aggregation of the local complexity evaluations.

The aggregated complexity evaluation has the advantage that a developer of the example-based system can easily carry out its quality assurance.

For example, a histogram about the complexity in the different surrounding areas of the input space is created as an aggregated complexity evaluation. For this purpose, the value range of the complexity evaluations is binned (that is to say, divided into regions). Preferably, solely the number of surrounding areas with corresponding complexity is collected in the bins if the positions of the surrounding areas are no longer required. This histogram is preferably combined with items of information about the number of examples, for example also in a histogram about the number of examples assigned to the representative. More preferably, items of information about the representatives are stored in the histogram so they can be drawn on in the case of detailed analyses.

According to a further preferred development, on the basis of the aggregated complexity evaluation, surrounding areas are identified whose complexity evaluation undershoots a predefined complexity threshold value. In the ascertained surrounding areas, the task of the example-based system is implemented by an algorithmic solution. This is particularly advantageous for applications with high demands on quality, for example in safety-oriented functions.

This preferred development is based on the finding that the exact mode of operation of the system (that is to say, semantic relationships) is frequently known for regions with low complexity of the task. In this case, the task can be implemented as a conventional algorithm (rather than as an example-based system). This is particularly advantageous since sufficient safety of the safety-oriented function can be more easily verified, as a rule, within the framework of an admission method for the simple algorithmic solution.

This development also provides the advantage that no further examples have to be acquired in the low-complexity regions.

In the search for simple regions, data collection artifacts are preferably also sought, which produce a relationship between input and output, which are provided by special circumstances of the data collection, but do not constitute a relationship which can be used in practice (as is known, for example, from what is referred to as the Kluger-Hans effect: https://de.wikipedia.org/wiki/Kluger_Hans). In regions with particularly high complexity, the examples are analyzed for whether problems have occurred, for example in the case of collection and acquisition of the examples.

According to a preferred embodiment of the inventive method, the complexity evaluation is based
on a comparison of the examples of the example set with one another and
a set division of the examples compared with one another.

The examples compared with one another are divided into sets:

$$ECS\_EE ( P ) = \{ x \vert x ∈ {P}^{2} ∧ {d}_{RE} ( x ) \leq {δ}_{in} ∧ {d}_{RA} ( x ) \leq {δ}_{out} \}$$

$$ECS\_EU ( P ) = \{ x \vert x ∈ {P}^{2} ∧ {d}_{RE} ( x ) \leq {δ}_{in} ∧ {d}_{RA} ( x ) > {δ}_{out} \}$$

$$ECS\_UE ( P ) = \{ x \vert x ∈ {P}^{2} ∧ {d}_{RE} ( x ) > {δ}_{in} ∧ {d}_{RA} ( x ) \leq {δ}_{out} \}$$

$$ECS\_UU ( P ) = \{ x \vert x ∈ {P}^{2} ∧ {d}_{RE} ( x ) > {δ}_{in} ∧ {d}_{RA} ( x ) > {δ}_{out} \}$$

where P is the example set and P² is the set of example pairs which can be formed from P.

In this case, d_{RE}(x) is the distance of the examples x₁, x₂ in the input space and d_{RA}(x) is the distance of the examples x₁, x₂ in the output space. Two examples have similar input feature values if the input space distance d_{RE}(x) is less than the predefined input delta δᵢₙ. Two examples have similar output feature values if the output space distance d_{RA}(x) is less than the predefined output delta δₒᵤₜ.

According to a further preferred embodiment of the inventive method, the input space is hierarchically divided on the basis of the quality evaluation.

Preferably, hierarchical mapping of the input space is achieved by the hierarchical division of the input space. The hierarchy is more preferably derived from the representation or encoding of the input feature and/or from the analysis of the complexity of the task.

On the basis of the introduction of an additional hierarchy in the analysis of the input space, in the regions in which a high complexity is present, the density of the representatives can be increased either dynamically (until a homogeneous complexity is achieved) or a new hierarchy level is introduced. The new hierarchy level is introduced by adding a new subdivision with a higher resolution in the region of the representative. The procedure can be iterated by adding a further hierarchy level in the high-resolution region with increased local complexity again. As a result, the resolution can be dynamically adapted to the respective task.

According to a further preferred embodiment of the inventive method, the example-based system is provided for use in a safety-oriented function, with the safety-directed function comprising an object identification based on sensor data in which the object is identified using the example-based system.

In a preferred development, the object identification is used during automated operation of a vehicle, in particular of a track-bound vehicle, a motor vehicle, an aircraft, a watercraft and/or of a space vehicle.

Object identification during automated operation of a vehicle is a particularly expedient embodiment of a safety-oriented function. Object identification is necessary in order to identify, for example, obstacles on the route or to analyze traffic situations with regard to the right of way of road users.

The motor vehicle is, for example, a motorcar, for example a passenger car, a heavy goods vehicle (HGV) or a track vehicle.

The watercraft is, for example, a ship or a submarine.

The vehicle can be manned or unmanned.

One example of a field of application is autonomous or automated driving of a rail vehicle. To achieve the task, object identification systems are used to analyze scenes, which are digitized with sensors. This scene analysis is necessary in order to identify obstacles on the route, for example, or to analyze traffic situations with regard to the right of way of road users. For the identification of the objects, particularly successful systems are currently being used which are based on the use of examples with which parameters of the pattern identification system are trained. Examples of this are neural networks, for example with deep learning algorithms.

According to a further preferred embodiment of the inventive method, the example-based system is provided for use in a safety-oriented function, with the safety-directed function comprising a classification based on sensor data of organisms.

The tissue classification of animal or human tissue is a particularly expedient embodiment of a safety-oriented function in the field of medical image processing. The organisms include, for example, archaea (archaebacteria), bacteria (true bacteria) and eucarya (nucleated) or tissue of Protista (also Protoctista, originators), Plantae (plants), fungi (fungi, chitin fungi) and Animalia (animals).

Further fields of application are the safe control of industrial plants (for example, synthesis in chemistry, the control of production processes, for example rolling mills), a classification of chemical substances (for example, environmental pollutants, warfare agents), a classification of signatures of vehicles (for example, radar or ultrasonic signatures) and/or control in the field of industrial automation (for example production of machines).

According to a further preferred embodiment of the inventive method, the example-based system comprises
a system with supervised learning,
a system constructed with the methods of statistics,
preferably an artificial neural network with one or more layer(s) of neurons which are not input neuron or output neuron and are trained with back propagation,
in particular, a convolutional neural network,
in particular a single-shot multibox detector network.

The use of artificial neural networks frequently makes it possible to improve the classification or approximation performance.

The one layer or multiple layers of neurons, which are not input neurons or output neurons, are often referred to by experts as concealed or “hidden” neurons. Training neural networks with many levels of hidden neurons is often also referred to by experts as deep learning. A special type of deep learning networks for pattern identification are what are known as convolutional neural networks (CNNs). A special case of the CNNs is what is referred to as SSD networks (Single Shot Multibox Detector Networks). The person skilled in the art understands the term “Single Shot Multibox Detector” to mean a method for object identification according to the deep learning approach, which is based on a convolutional neural network and is described in: Liu, Wei (October 2016). SSD: Single shot multibox detector. European Conference on Computer Vision. Lecture Notes in Computer Science. 9905. pp. 21-37. arXiv: 1512.02325

According to a further preferred embodiment of the inventive method, the procedure in quality assurance of the system takes place according to the procedure with the V-model for carrying out a development process.

In other words: according to this embodiment, the procedure model is the V-model for carrying out a development process.

The term “V-model for carrying out a development process” is preferably understood by a person skilled in the art to be the V-model described at https://de.wikipedia.org/wiki/V-Modell. According to the embodiment, the activities of the procedure are mapped to the V-model. That is to say, the above-described quality assurance is applied in the different steps of the V-model.

In a preferred development, the example-based portion of the system is defined in a first step of the procedure. In other words, the elements of the system which are designed as an example-based subsystem are defined.

It is preferably taken into account which subtasks of the system may be usefully processed by means of an example-based system, such as an artificial neural network.

According to a further preferred development, the collection of the examples is specified in a further step of the procedure.

For example, it is specified how many examples are to be collected, which features are to be characterized, which examples are divided among the training data set and/or the test data set. In addition, the validation is specified, for example.

According to a further preferred development, safety demands and a safe state of the system are defined in a further step of the procedure.

Preferably, the safe state is defined on the basis of demands which must be met in order for the system to be classified as being in the safe state.

In a further preferred development, in a further step of the procedure
the quality assurance is defined for the examples,
the examples are collected and
an initial quality assurance of the examples is carried out.

This further step should preferably be assigned to the step of “System demand analysis” (see https://de.wikipedia.org/wiki/V-Modell) or English “Specification of System Requirements”, which takes place within the framework of the procedure with the V-model.

The quality assurance for the examples is preferably defined in such a way that the quality evaluation to be applied, which is intended to be the basis for the quality assurance of the example-based subsystem, is selected or automatically ascertained.

For example, for the initial quality assurance, the quality evaluation described above, which represents the coverage of the input space by examples, is applied for quality assurance (for example, as mapping of the input space). Alternatively and/or in addition, the above-described complexity evaluation can also be used as a quality evaluation for quality assurance.

According to a further preferred development, in a further step of the procedure,
a modularization of the overall task to be achieved by the subsystem,
a transformation of the examples,
a representation of the examples,
an encoding of the examples and
a network structure of an artificial neural network of the example-based subsystem
   are defined.

The modularization of the overall task to be achieved by the subsystem is preferably to be understood to mean that the overall task to be achieved by the example-based subsystem is divided into subtasks. The division into subtasks takes place in a modular manner, that is to say, there is a possible compiling of the subtasks, which represents the overall task.

For the definition of the network structures, the modulation of the subtasks has the result, for example, that the artificial neural networks of the example-based subsystem are divided into subnetworks. Alternatively or in addition, subtasks can be achieved or processed by way of a symbolic or conventional implementation while other subtasks are achieved or processed via an artificial neural network.

Examples of subnetworks are described in Section 3.9 (“Hierarchisches QUEEN Perzeptronen-Netz (HQPN)”) [Hierarchical QUEEN Perceptron Network”] by WASCHULZIK. Thus, a subtask can be achieved by a subnetwork of a HQPN or by a subnetwork, which is an HQPN and is arranged parallel to further HQPNs in the network structure.

The representations are, for example, geographic representations, such as GPS coordinates, zip codes, etc.

Once the modularization, the transformation, the representation, the encoding and the network structure have been defined in this step of the procedure, the quality assurance for the examples can be adapted once again in an iteration, further or other examples can be collected and an initial quality assurance of the examples can be adapted or carried out again.

In a further preferred development, in a further step of the procedure,
modules which are generated during modularization and are subnetworks of the artificial neural network,
the transformation of the examples,
the representation of the examples,
the encoding of the examples and
the artificial neural network
   are implemented.

The modules are, for example, subnetworks of an artificial neural network.

This further step should preferably be assigned to the “Software design” step (cf. https://de.wikipedia.org/wiki/V-Modell) or English “Design and Implementation”, which takes place in the framework of the procedure with the V-model.

According to a further preferred development, in a further step of the procedure,
the transformation of the examples,
the representation of the examples,
the encoding of the examples and
the training and the testing of the artificial neural network are carried out.

This further step should preferably be assigned to the step of creating the system (English: “Manufacture”), which takes place in the framework of the procedure with the V-model.

According to a particularly preferred development, a protected region of the input space is ascertained on the basis of the quality evaluation and the artificial neural network is exclusively applied in the protected region.

For example, a region of the input space in which a sufficient example set has been acquired or in which the complexity evaluation is comparatively low in terms of the safety demands is selected as the protected region.

According to a further preferred development, in a further step of the procedure, the modules are integrated by taking into account knowledge about a protected region, with the knowledge being obtained on the basis of the quality evaluation.

This further step should preferably be assigned to the “System integration” step (cf. https://de.wikipedia.org/wiki/V-Modell) or English “Integration”, which takes place in the framework of the procedure with the V-model.

A person skilled in the art preferably understands the term “integrated” as a linking of the modules to form an overall system.

During integration, knowledge about the local reliability of the information in the example set is taken into account.

In a further preferred development, the track of an example is followed by monitoring the neurons of the artificial neural network which are excited by the example.

In this way, it is ensured that statements can be made with sufficient reliability for the processing of an example in the modules.

The excited neurons are monitored, for example, on the basis of an assignment of the example to be processed to a part of the input space. Those neurons which are excited when the example is present can be monitored on the basis of the knowledge about to which part of the input space the example is to be assigned. It is possible to follow the track of the example up to the output via the connections of the neurons to one another.

In a further preferred development, the example-based subsystem is validated on the basis of a validation example set which comprises independent validation examples.

The person skilled in the art understands the term “independent validation examples” preferably as an example set which is independent of previously acquired examples.

This further step should preferably be assigned to the “System validation” step or English “System Validation”, which takes place in the framework of the procedure with the V-model.

Preferably, a trained example-based subsystem is validated by means of a validation example set. Accordingly, the training example set forms a first example set comprising a plurality of examples, and the validation example set comprises a second example set comprising a plurality of examples. For the first example set, preferably a first quality evaluation and for the second example set, preferably a second quality evaluation is ascertained. The first quality evaluation and second quality evaluation are preferably compared with one another.

Further, for example, a third example set is formed from the first and second example sets and a third quality evaluation is ascertained for the third example set. Furthermore, the first quality evaluation, the second quality evaluation and the third quality evaluation are compared.

The third example set represents the combination set, as it were, of the first and second example sets.

An example of the application of the third example set is a constellation in which the second example set (namely, the validation example set) is collected in the presence of knowledge which was obtained on the basis of the first example set (training sample set). According to a further preferred embodiment of the method, in a further step of the procedure,
creation examples, which are acquired for the creation of the example-based subsystem, are assigned to a first example set,
application examples, which are acquired in the application of the example-based subsystem, are assigned to a second example set and
a first quality evaluation, which is ascertained on the basis of the first example set, and a second quality evaluation, which is ascertained on the basis of the second example set, are compared with one another.

The further step of the procedure takes place, for example, in a loop in the development or in the step of “Operation, maintenance and performance monitoring” (English: “Operation, Maintenance and Performance Monitoring”). The examples acquired within the framework of the application of the system are collected [ ] an example set (application examples). This example set is compared with the example set (creation examples), which was used for the creation of the system. In particular, the comparison of the complexity evaluation of the application examples with the complexity evaluation of the creation examples can be carried out over a period of operation and a drift of the complexity evaluation is can be identified.

According to a further preferred embodiment of the method, in which the respective example of the example set comprises an input value which lies in an input space, in a further step of the procedure,
creation examples, which are acquired for the creation of the example-based subsystem, are assigned to a first example set,
further examples, which are generated on the basis of input values distributed in the input space by the example-based subsystem, are assigned to a second example set, and
a first quality evaluation, which is ascertained on the basis of the first example set, and a second quality evaluation, which is ascertained on the basis of the second example set, are compared with one another.

Accordingly, the training example set or a subset thereof forms a first example set which comprises a plurality of examples. A first quality evaluation is ascertained for the first example set. A second example set is ascertained by applying the trained exampled-based subsystem (for example the neural network). For this purpose, input values (measurement points) can be distributed randomly or systematically in the input space. An output vector is determined by the example-based subsystem for each input vector. The second example set is formed on the basis of these examples generated by the example-based subsystem. A second quality evaluation is then ascertained for this second example set. The first and second example sets are compared on the basis of the first and second quality evaluations.

Further, for example, a third example set, which forms the union set of the first and second example sets, is formed from the first and second example sets, and a third quality evaluation is ascertained for the third example set. Further, the first quality evaluation, the second quality evaluation and the third quality evaluation are compared.

If, for example, regions are found in the space where increased local complexity occurs in the union set (on the basis of the third quality evaluation), it is possible to infer a poor generalization of the example-based subsystem. These regions are identified and measures are taken to rectify the problem. This can be achieved, for example, by changes in parameters of the neural network used (for example, correction of the number of degrees of freedom in the region of the input space with poor quality), by acquiring further examples, by changing the training parameters or by inserting regularization terms.

The invention further relates to a computer program comprising commands which, when the program is executed by a computing unit, cause the computing unit to carry out the method of the type described above.

The invention further relates to a computer-readable storage medium comprising commands which, when executed by a computing unit, cause the computing unit to carry out the method of the type described above.

Reference can be made to the above description relating to the corresponding features of the inventive method with regard to advantages, embodiments and embodiment details of the features of the inventive computer program and computer-readable storage medium.

An exemplary embodiment of the invention will be explained on the basis of the drawings. In the drawings:

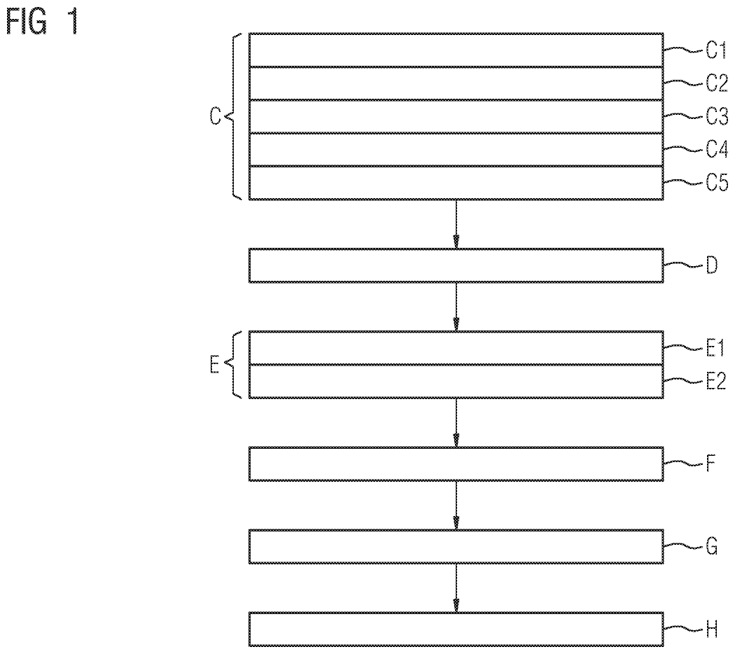

FIG. 1 schematically shows the sequence of an exemplary embodiment of an inventive method,

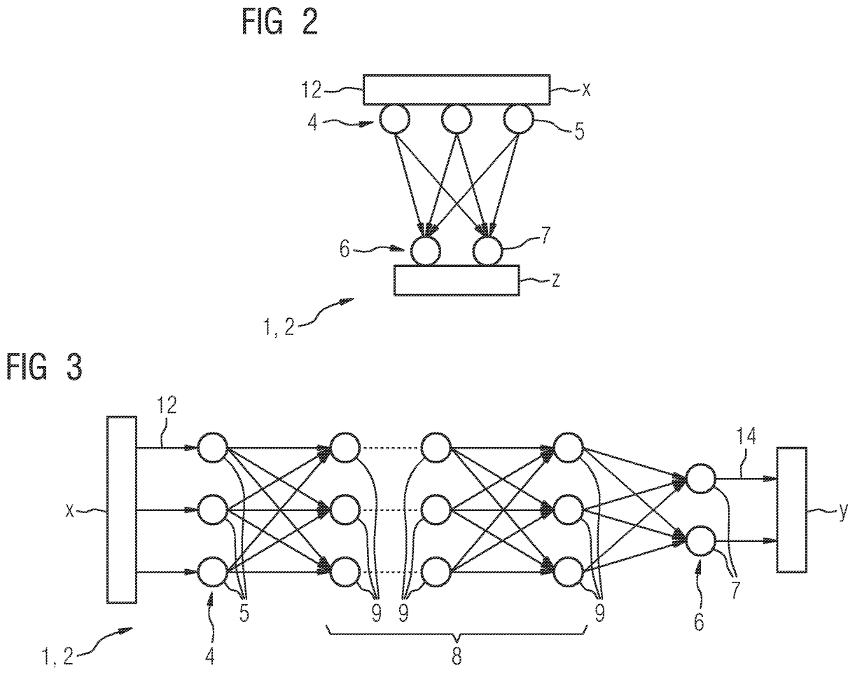

FIG. 2 schematically shows the structure of an example-based system with unsupervised learning,

FIG. 3 schematically shows the structure of an example-based system with supervised learning according to the exemplary embodiment of the inventive method,

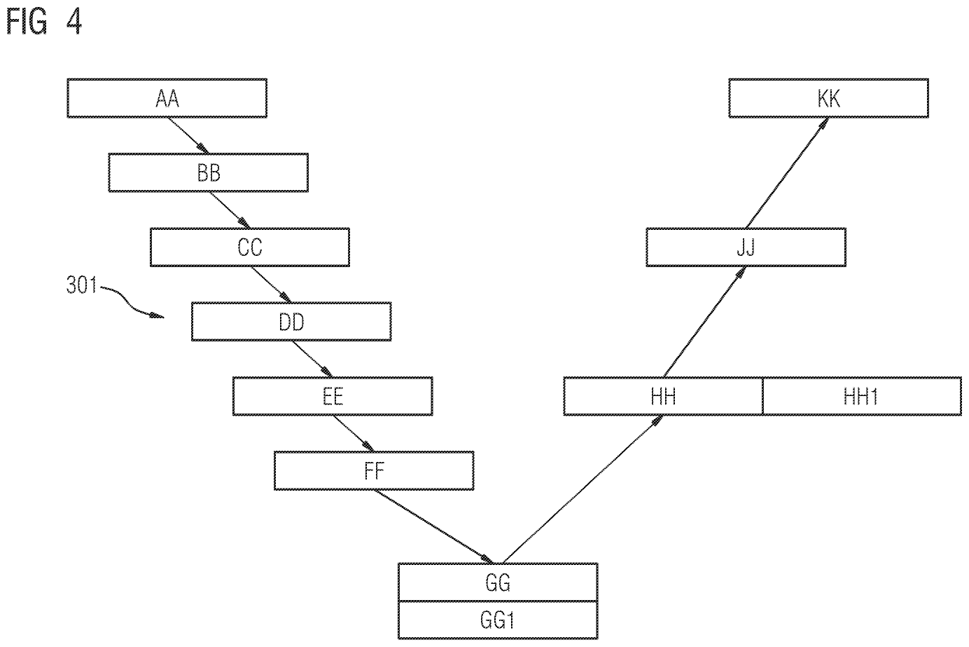

FIG. 4 schematically shows the sequence of a procedure in the quality assurance of a system according to an exemplary embodiment of the inventive method,

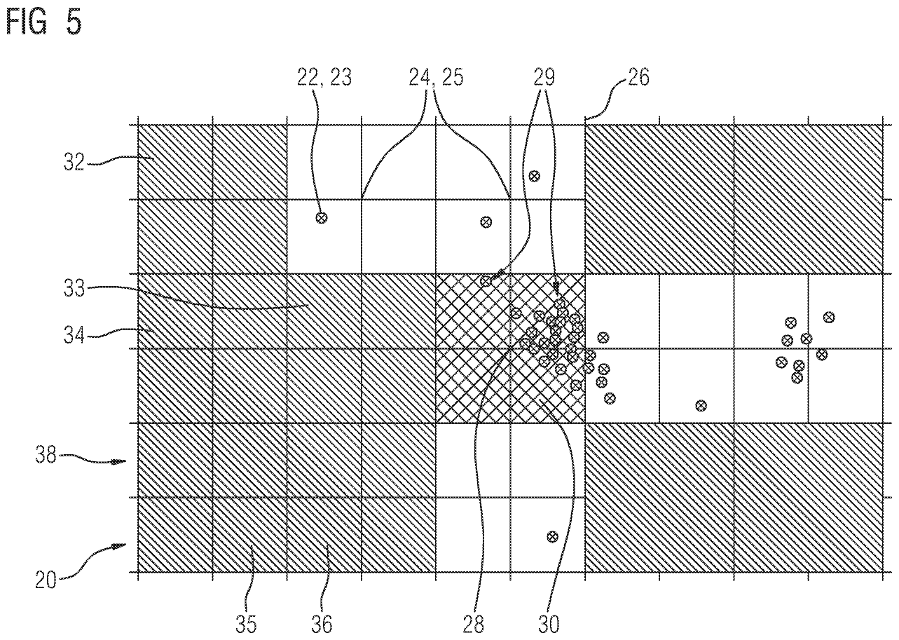

FIG. 5 schematically shows a two-dimensional input space according to the exemplary embodiment of the inventive method,

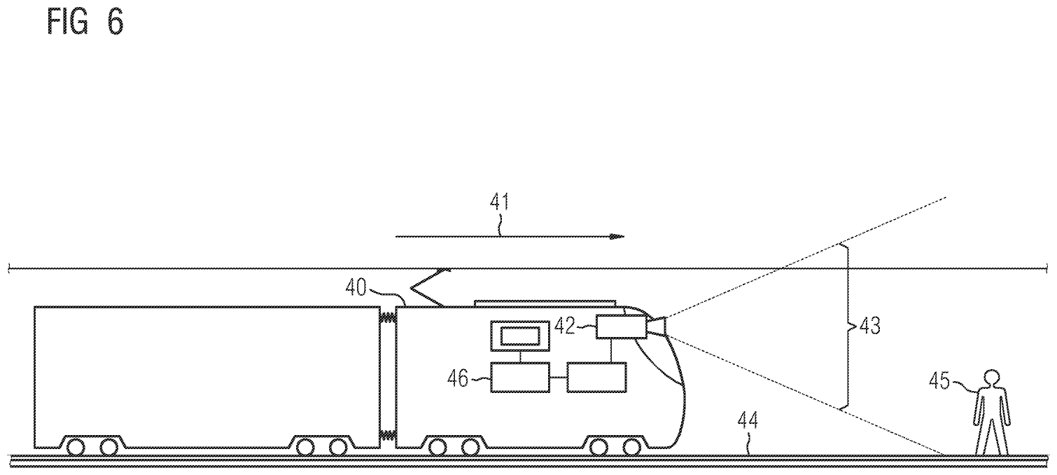

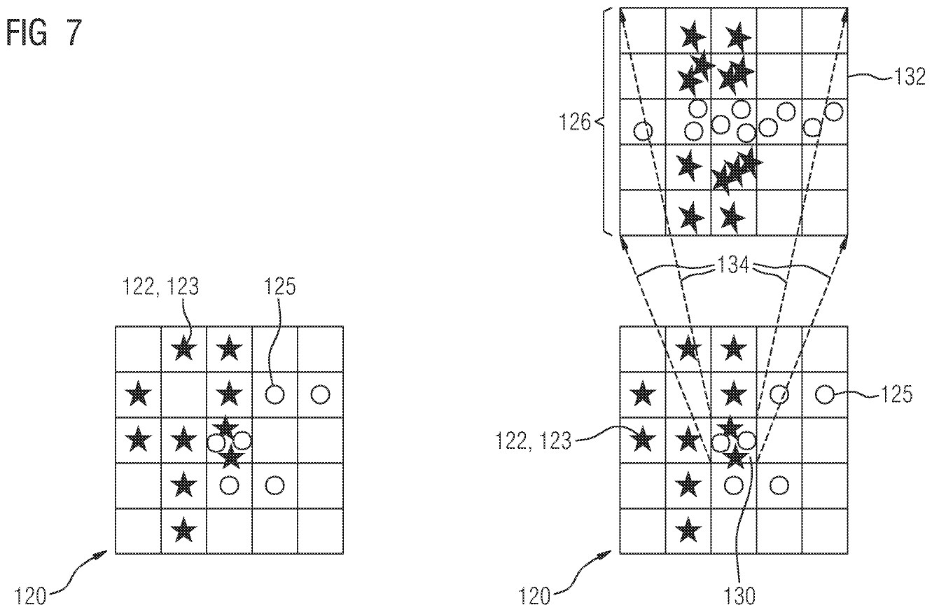

FIG. 6 shows a schematic side view of a track-bound vehicle located on a route,

FIG. 7 shows a hierarchical division of the input space,

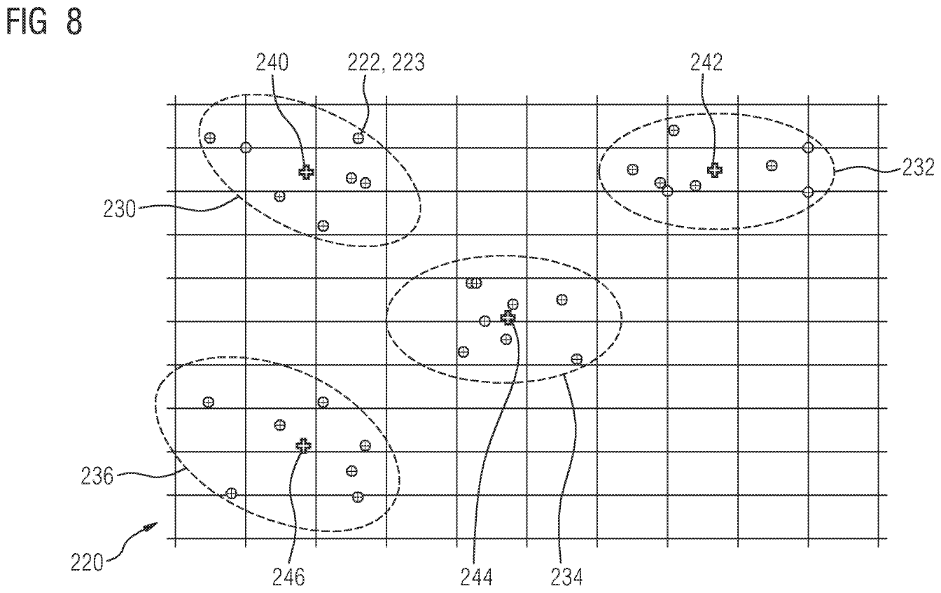

FIG. 8 schematically shows a further example of a two-dimensional input space according to a further exemplary embodiment of the inventive method,

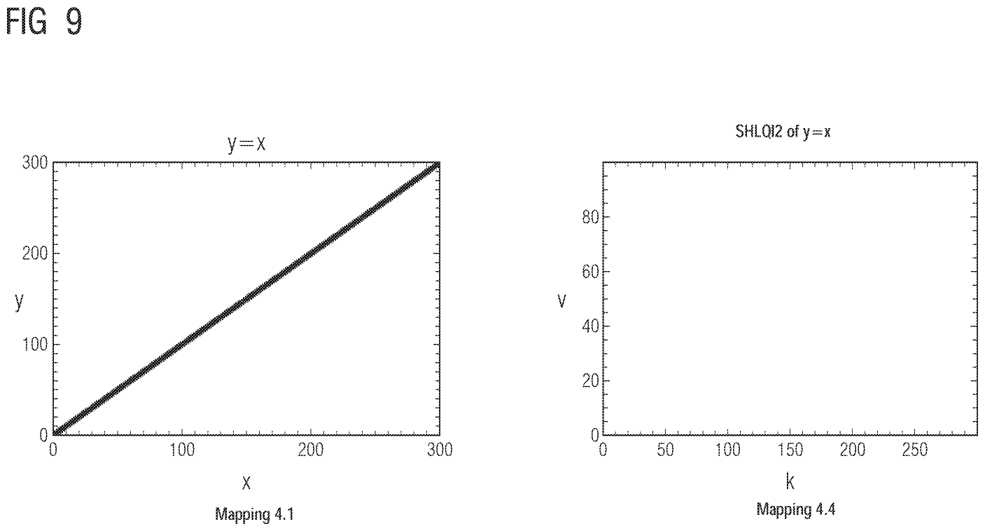

FIG. 9 shows two axis graphs which represent the application of the complexity evaluation to a first synthetic function,

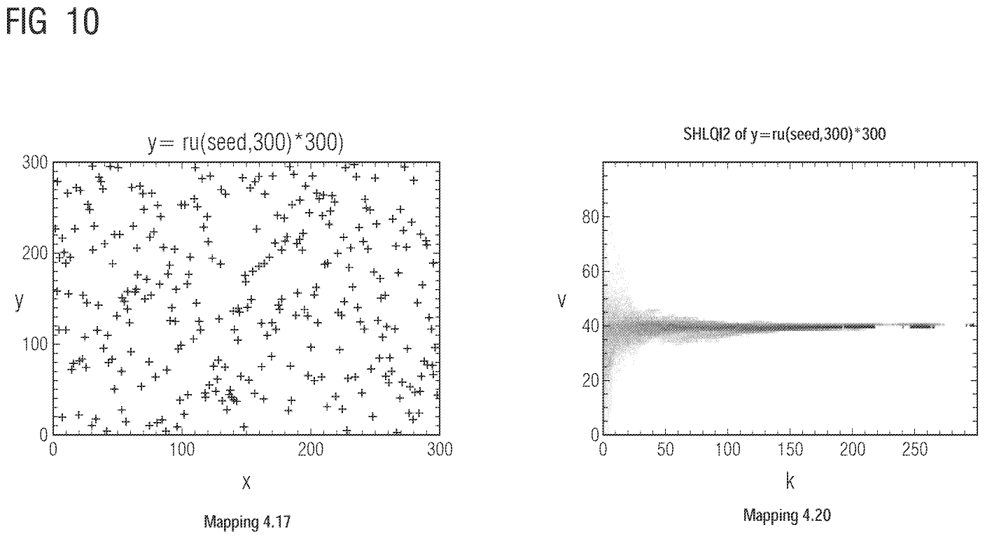

FIG. 10 shows two axis graphs which represent the application of the complexity evaluation to a second synthetic function, and

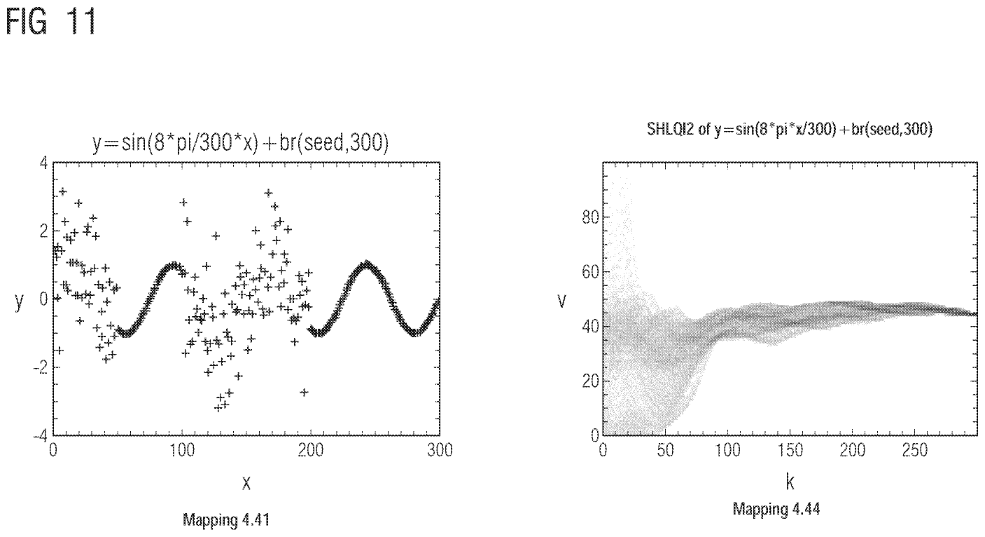

FIG. 11 shows two axis graphs which represent the application of the complexity evaluation to a third synthetic function.

FIG. 1 shows a schematic flowchart which represents the sequence of an exemplary embodiment of an inventive method for quality assurance of a system.

FIG. 6 shows an exemplary embodiment of a system in the form of a track-bound vehicle 40. The system has an example-based subsystem 46.

The method can basically be applied to exampled-based subsystems with supervised and unsupervised learning.

In supervised learning, the aim is to learn a function which maps data x (as input values) to a label y. An example of supervised learning is the classification in which, for example, image data x is mapped to a class y (for example, cats). Further examples of supervised learning are regression, object identification, image labeling, etc.

In unsupervised learning, the aim is to learn a structure of data x (without using a label y). An example of unsupervised learning is clustering in which groups are to be found within the data, which have similarities in a particular metric. Further examples of unsupervised learning are dimensionality reduction or learning of features (what is referred to as feature learning or representation learning), etc.

FIGS. 2 and 3 show exemplary embodiments of example-based subsystems 1. FIG. 2 schematically shows the structure of an exemplary embodiment of an example-based subsystem 1, which is designed as an autoencoder. Autoencoders are one type of artificial neural network 2 which can be used for efficient data encoding and learn this capability in an unsupervised manner. The autoencoder maps the input values x to a feature vector Z.

FIG. 3 schematically shows the structure of an exemplary embodiment of an example-based subsystem 1 with supervised learning, which is designed as a multi-layer perceptron.

Further examples of subsystems with supervised learning can be a recurrent neural network, a convolutional neural network or, in particular, what is referred to as a single-shot multibox detector network.

The example-based subsystem 1 is formed by an artificial neural network 2 which has a layer 4 of input neurons 5 and a layer 6 of output neurons 7.

The artificial neural network 2 shown in FIG. 3 has a plurality of layers 8 of neurons 9 which are not input neurons 5 or output neurons 7.

The example-based subsystem and the inventive method are implemented by means of one or more computer program(s). The computer program comprises commands which, when the program is executed by a computing unit, cause the computing unit to carry out the inventive method in accordance with the exemplary embodiment shown in FIG. 1. The computer program is stored on a computer-readable storage medium.

The example-based subsystem is used in a safety-oriented function of a system. The behavior of the function therefore has an influence on the safety of the environment of the system. An example of a safety-oriented function is object identification based on an image identification in which the object is identified using the example-based subsystem 1 (in the case of supervised learning). Object identification is used, for example, in the case of automated operation of a vehicle, in particular of a track-bound vehicle 40 shown in FIG. 6, of a motor vehicle, of an aircraft, of a watercraft or of a spacecraft.

A further example of a safety-oriented function is a classification based on sensor data from organisms, for example archaea (archaebacteria), bacteria (true bacteria) and eucarya (nucleated) or tissue from Protista (also Protoctista, originators), Plantae (plants), fungi (fungi, chitin fungi) and Animalia (animals), safe control of industrial plants, a classification of chemical substances, a classification of signatures of vehicles or control in the field of industrial automatization.

The exemplary embodiment of the inventive method will be described below on the basis of a track-bound vehicle 40 as a system on which the quality assurance is to be carried out. However, the inventive method can of course be applied to alternative systems, such as a system consisting of a fleet of track-bound vehicles and an environment of the fleet (infrastructure).

According to the inventive method, the quality assurance of the example-based subsystem 46 takes place on the basis of a procedure model which represents a plan for the procedure in the quality assurance of the system. The procedure model used is the V-model 301 shown in FIG. 4. A person skilled in the art preferably understands the term “V-Model for carrying out a development process” to mean the V-model described at https://de.wikipedia.org/wiki/V-Modell.

According to a first step of the procedure, the example-based portion of the system 1 is defined in a method step AA. In particular, it is defined which elements of the track-bound vehicle 40 shown in FIG. 6 are designed or implemented as an example-based subsystem 46. Thus, for example, one element of the object identification is designed as a play-based subsystem 46.

The collection of the examples is specified in a further method step BB of the procedure. For example, it is specified how many examples are to be collected, in what manner the examples are to be collected, which features are to be characterized, which examples are distributed among a training data record and/or a test data set. In addition, for example, the validation is specified.

The collected examples form an example set. The respective example has an input value 12 which lies in an input space and an output value 14 which lies in an output space. In object identification (as one of a plurality of possible examples of a safety-oriented function in supervised learning), for automated operation of the track-bound vehicle 40 shown in FIG. 6, the examples are collected by providing the track-bound vehicle 40 with a camera unit 42 for acquiring images. The camera unit 42 is oriented in the travel direction 41 in such a way that a spatial region 43 located ahead in the direction of travel 41 is captured by the camera unit. The track-bound vehicle 40 travels with the camera unit 42 in the direction of travel 41 along a route 44. To acquire the examples, scenes which are relevant to the creation and training of the example-based system 1 for object identification are reconstructed. Thus, for example, cardboard figures, crash test dummies or actors 45 are used to represent people on the route 44 who are to be identified by means of the example-based system 1 which is to be created and trained. Alternatively, scenes can be reconstructed by means of what is referred to as virtual reality.

In a further method step CC of the procedure, safety requirements and a safe state of the system are defined. In particular, the safe state is defined on the basis of demands which must be met in order that the system can be classified as being in the safe state.

According to a further method step DD, the quality assurance is defined for the examples, the examples are collected and an initial quality assurance of the examples is carried out. This further step should be assigned to the step of “System demand analysis” (see https://de.wikipedia.org/wiki/V-Modell) or English “Specification of System Requirements”, which takes place in the framework of the procedure with the V-model. The quality evaluation to be applied, which should be the basis for the quality assurance of the example-based subsystem 46, can be selected by a user or be automatically ascertained.

For example, for the initial quality assurance, a quality evaluation which represents the coverage of the input space by examples is applied for the quality assurance. Alternatively and/or in addition, the above-described complexity evaluation is applied as a quality evaluation for the quality assurance.

These two types of quality evaluation will be explained below, by way of example, on the basis of FIGS. 5 and 7 to 11:

In a method step C, a quality evaluation, which represents a coverage of the input space by examples of the example set, is ascertained. In the ascertainment C of the quality 26 evaluation, representatives are distributed in the input space in a method step C1. FIG. 5 shows, as an example, a two-dimensional input space 20. When the inventive method is actually applied, the input space and the output space frequently have a higher dimensionality. The examples 22 of the example set are shown as crosshairs 23 in FIG. 5. The representatives 24 are uniformly distributed and are shown as cross-points 25 of the grid 26 shown.

In a method step C2, a number of examples 29 of the example set is assigned to a respective representative 28. The examples 29 assigned to the representative 28 lie in a surrounding area 30 of the input space 20, which surrounds the respective representative 28. The surrounding area 30 is illustrated by way of example in FIG. 3 as a dotted area. In a method step C3, a local quality evaluation for the surrounding area 30 is ascertained as a quality evaluation.

In a method step C4, surrounding areas 32-36, for example adjacent in the input space, are ascertained to whose respective representative a number of examples which undershoot a predefined quality threshold value is assigned. In FIG. 5, these surrounding areas 32-36 are shown as areas with diagonal stripes. In the example shown in FIG. 5, the surrounding areas 32-36 are areas in which there is no example. In addition, in a method step C5, a relationship area 38 is ascertained within the input space 20, which consists of the adjacent surrounding regions 32-36 to whose representatives a number of examples respectively which undershoot a predefined quality threshold value is assigned. As a result, the position and size of regions of the input spaces 20 are ascertained in which too few examples have been acquired. In other words:

subregions of the input spaces 20 are identified in which the example values do not provide a sufficient basis for a safety-critical application.

Corrective interventions can be made on the basis of the identification: for this purpose, for example in a method step D in a respective surrounding area, further examples are acquired if the quality evaluation ascertained for the respective surrounding area is less than a predefined threshold value.

In a method step E, a local complexity evaluation is ascertained for the respective surrounding area, which represents a complexity of a task of the example-based system which is defined by the examples of the surrounding area. The local complexity evaluation is determined according to a method step E1 by the relative position of the examples of the surrounding area with respect to one another in the input space 20 and the output space. That is to say, the complexity evaluation is defined on the basis of consideration of the similarity of the distances of the examples in the input space 20 to the distances in the output space. For example, the task of the example-based system has a comparatively low complexity if the distances in the input space 20 (irrespective of the scaling) approximately correspond to the distances in the output space. Regions in which a comparatively high number of examples have to be acquired due to high complexity of the task of the example-based systems are ascertained on the basis of the complexity evaluation. For example, in regions of the input space 20 in which a higher complexity is present, the density of the representatives is dynamically increased until a homogeneous complexity is achieved.

Alternatively, a new hierarchical level can be introduced (as described, by way of example, with respect to FIG. 7 below). The complexity evaluation corresponds to the quality indicators described in Section 4 (QUEEN quality indicators) by WASCHULZIK. These quality indicators can be defined and applied for the representation or encoding of the features (cf. section 4.5 of WASCHULZIK). An example of this quality indicator for the representations is the integrated quality indicator QI² according to section 4.6 of WASCHULZIK.

In a method step E2, an aggregated complexity evaluation is ascertained by aggregation of the local complexity evaluation: for example, a histogram about the complexity in the different surrounding areas of the input space is created as an aggregated complexity evaluation. For this purpose, the value range of the complexity evaluation is binned (that is to say, divided into regions). Solely the number of surrounding areas with corresponding complexity is collected in the bins if the positions of the surrounding areas are no longer required. This histogram is combined with items of information about the number of examples, for example also in a histogram about the number of examples assigned to the representative. More preferably, items of information about the representatives are preferably stored in the histogram so it can be drawn on in the case of detailed analyses.

On the basis of the complexity evaluation, it is possible to detect in a method step F whether an appropriate number of examples has been acquired in all regions. If a region is identified in which too many examples with low complexity have been acquired, examples can be removed from this region. This reduction of the examples reduces the memory space requirement and the costs for the calculations, for example for the quality-assuring measures on the basis of the example data set. If a region is identified in which too few examples have been acquired (for example, since the complexity is comparatively high), further examples possibly have to be acquired in this region. The latter case frequently occurs in the regions in which a new hierarchy level has been introduced (as described, by way of example, with respect to FIG. 7 below). After the acquisition of further examples, a loop for quality assurance (according to method steps C to E) is run through until all desired quality demands are met.

On the basis of the aggregated complexity evaluation, in a method step G, surrounding areas are identified whose complexity evaluation undershoots a predefined complexity threshold value. In the ascertained surrounding areas, the task of the example-based system is implemented according to a method step H by an algorithmic solution if the mode of operation of the system (that is to say, semantic relationships) are known for the surrounding area. The task of the system is accordingly implemented as a conventional algorithm (instead of as an example-based system). For the regions of the input space for which a statistical system or a neural network is to be implemented, the statistical system is also created in step H or the structure of the neural network is defined and the neural network is trained.

In the method described above, loops can be provided in the development. For example, it is conceivable that no solution can be found on the basis of the features initially identified, with which the desired quality requirements can be met. In this case, it is possibly necessary to return to a preceding step and to determine suitable features. On this basis, examples which are to be acquired are re-defined and the method is run through again. Further loops can be provided between the individual steps, for example in order to acquire additional examples if the acquired examples are not sufficient to meet the desired quality requirements.

FIG. 7 shows, by way of example, a hierarchical division of an input space 120 by way of which hierarchical mapping of the input space is achieved. The collected examples 122 8 of the example set are represented as stars 123 and circles in FIG. 7. The stars 123 and circles 125 are examples of different object classes (that is to say, have a different position in the output space).

A new hierarchy level 126 can additionally be introduced in the regions in which a high complexity is present. The new hierarchy level 126 is introduced, for example, by adding a new subdivision 132 with a higher resolution 134 in the region 130. The procedure can be iterated by adding a further hierarchy level in the high-resolution range with increased local complexity again.

As an alternative to the exemplary embodiment described with respect to FIG. 5, according to which representatives are uniformly distributed in the input space, FIG. 8 shows an exemplary embodiment of an input space 220 in which the representatives each form a center of a cluster, which is determined by means of a clustering method. Examples 222 of the example set are represented in FIG. 8 as crosshairs 223.

FIG. 8 shows, by way of example, four clusters 230, 232, 234 and 236, each comprising a plurality of examples. These examples are located within a dashed boundary line in the representation, which, however, does not represent an actual boundary of a cluster, but has been drawn solely for illustration. The clusters 230, 232, 234 and 236 each have an associated cluster center 240, 242, 244 and 246 (represented as a plus shape). The cluster centers 240, 242, 244, 246 are each located centrally within the cluster and are assigned to a cluster independently of the boundaries of the grid of the input space.

The clusters according to FIG. 8 have the advantage that they particularly suitably represent the topology of the data. The grid according to FIG. 5 has the advantage that the regions which are not covered are more suitably mapped. For example, the coverage of the input space (according to method step C) can be calculated via the grid and the complexity evaluation (according to method step E) in addition to the grid, can also be calculated via the cluster center. Which approach is most suitable can also depend on the method of the neural network. If the encoding neurons can move in the input space, then the cluster approach is preferably selected or the cluster centers are equated with the positions of the encoding neurons in the input space.

In order to obtain an understanding of the properties and the behavior of the quality indicators described in WASCHULZIK as examples of a complexity evaluation, it is helpful to apply these to synthetic functions (for example y=x). From this, it can be concluded how these quality indicators can be applied in example-based systems.

FIGS. 9 to 11 each show a histogram of the distribution of the complexity evaluation over k-nearest neighbors of a preselected example for a synthetic function. The example is, for example, a proxy example or a center of a cluster (as described above). The example can also be an example selected from the surrounding area of a representative, which has been selected for a more in-depth examination with regard to the complexity of the task.

On the left, FIG. 9 shows the mappings 4.1 and on the right, the mapping 4.4 of WASCHULZIK. As a synthetic function, on the left, FIG. 9 shows y=x as an axis graph (the entries in the axis graph are shown as “+”). The axis graph on the right shows a histogram SHLQ² of QI² over the k-nearest neighbors of an example for the function y=x. It is clear that for any local environments k of an example, the histogram SHLQ² shown has the value zero.

On the left, FIG. 10 shows the mapping 4.17 and on the right, the mapping 4.20 of WASCHULZIK. As a synthetic function, on the left, FIG. 10 shows y=ru(seed, 300)*300 as an axis graph. This is a uniformly distributed random variable with values between 0 and 300. The axis graph on the right shows the histogram SHLQ² of QL² over the k-nearest neighbors of an example for the function y=ru(seed,300)*300. The axis graph on the right in FIG. 9 is scaled in such a way that 40 stands for the value 1.

On the left, FIG. 11 shows the mapping 4.41 and on the right, the mapping 4.44 of WASCHULZIK. As a synthetic function, on the left, FIG. 11 shows y=sin(8*pi*x/300)+br(seed,300) as an axis graph. It is a sine function which has a stochastic noise in the ranges 0<x≤50 and 100<x≤200. The axis graph on the right shows the histogram SHLQ² of QI² over the k-nearest neighbors of one example of the function y=sin(8*pi*x/300)+br(seed,300). The axis graph in FIG. 11 is scaled in such a way that 40 stands for value 1. From this representation the person skilled in the art can see that there is a plurality of k-neighborhoods up to size approx. 45 in which the value of QI² is almost 0 (to be seen by the dark gray shading of the bins with a small number plotted on the V-axis) and therewith an almost linear mapping of the input and output spaces is present. If by reading out the information in the histogram the person skilled in the art now analyzes in the environment which examples the low complexity is present, he thus obtains the example with x=75 in whose neighborhood k=45 the complexity is very low. The same applies to x=225 or x=275 for k=45. Thus, the person skilled in the art can easily, quickly and reliably identify the regions in which the complexity is particularly low or high without prior knowledge of how the examples are distributed in the input space. By reading out the bins with the high values, even in large environments, he can identify regions of high complexity (for example bin number 80 at K=20). The regions with high or low complexity can be identified independently of the dimension of the input and output space since the distance of the k-nearest neighbor can be determined in spaces of any dimensionality. By way of a similar procedure, the person skilled in the art can also identify the representatives from the histograms via the size of the related regions, which contain, for example, very few examples. The position in the input space in which further examples have to be acquired can then be determined via the representatives.

Two types of quality evaluations have been explained by way of example above on the basis of FIGS. 5 and 7 to 11. These quality evaluations can be applied within the framework of the procedure in the V-model 301. For example, the quality evaluations described above can be applied in the initial quality assurance of examples 22 according to method step DD. However, they can also be used in further steps in the procedure according to the V-model 301.

The loops described above can be used to iteratively acquire examples: for example, the above-mentioned acquired examples for the initial quality evaluation form a first example set. A further data set is acquired in a further measuring campaign. For example, the acquisition of the second example set can be identified on the basis of findings from the first example set. A first quality evaluation is ascertained (as described above) for the first example set. Analogously to this, a second quality evaluation is ascertained for the second example set. These two quality evaluations can be compared. It can be established whether the modified acquisition has the expected influence on the second quality evaluation. In addition, the first and second example sets can be combined to form a third example set (union set), and a third quality evaluation can be ascertained on the basis of the third example set. If this union set does not meet the expected quality demands, then possible problems in the modified acquisition can be inferred. These problems can be analyzed and rectified with the above-described methods.

According to a further method step EE of the procedure, a modularization of the overall task to be achieved by the subsystem 46, a transformation of the examples 22, a representation of the examples, an encoding of the examples and a network structure of an artificial neural network of the exampled-based subsystem 46 are defined.

In the modularization of the overall task to be achieved by the subsystem 46, the task to be achieved by the example-based subsystem 46 is divided into subtasks. The division into subtasks takes place in a modular manner, that is to say, there is a possible compiling of the subtasks which represents the overall task.

For the definition of the network structures, the modulation of the subtasks has the result, for example, that the artificial neural networks of the example-based subsystem 46 are divided into subnetworks. Alternatively or in addition, subtasks can be achieved or processed via a symbolic or conventional (algorithmic) implementation, while other subtasks are achieved or processed via an artificial neural network.

Examples of subnetworks are described in Section 3.9 (“Hierarchical QUEEN Perceptron Network (HQPN)”) by WASCHULZIK. Thus, a subtask can be achieved by a subnetwork of a HQPN or by a subnetwork which is an HQPN and is arranged parallel to further HQPNs in the network structure.

In a further method step FF of the procedure, modules generated during modularization, which are subnetworks of the artificial neural network, the transformations of examples 22, the representation of examples 22, the encoding of examples 22 and the artificial neural network are implemented.

The modules are, for example, subnetworks of an artificial neural network.

This further method step FF should be assigned to the “Software design” step (cf. https://de.wikipedia.org/wiki/V-Modell) or English “Design and Implementation”, which is carried out in the framework of the procedure with the V-model 301.

In a further method step GG of the procedure, the transformation of examples 22, the representation of examples 22, the encoding of examples 22 and the training and testing of the artificial neural network are carried out.

This further method step GG should be assigned to the step of creating the system (English: Manufacture), which is carried out in the framework of the procedure with the V-model 301.

A protected region of the input space 20 is ascertained on the basis of the quality evaluation and the artificial neural network is applied exclusively in the protected region according to a method step GG1. For example, a region of the input space 12 in which a sufficient example set has been acquired or in which the complexity evaluation is comparatively low in terms of the safety requirements is selected as a protected region.

By taking into account knowledge about a protected region, the modules are integrated in a method step HH, with the knowledge being obtained on the basis of the quality evaluation. This further method step HH should preferably be assigned to the “System integration” step (cf. https://de.wikipedia.org/wiki/V-Modell) or English “Integration”, which takes place in the framework of the procedure with the V-model 301. The modules are combined with one another to form an overall (sub) system. Knowledge about the local safety of the information in the example set is taken into account in the integration.

In a method step HH1, the track of an example is followed by monitoring the neurons of the artificial neural network excited by the example 22. In this way, it is ensured that statements can be made with sufficient reliability for the processing of an example 22 in the modules. The excited neurons are monitored, for example, on the basis of an assignment of the example 22 to be processed to a part of the input space. Those neurons which are excited when the example 22 is present can be monitored on the basis of the knowledge about to which part of the input space the example is to be assigned. Following the track of example 22 up to output y is possible via the connections of the neurons to one another.

In a further method step JJ of the procedure, the example-based subsystem is validated on the basis of a validation example set which comprises independent validation examples. The independent validation examples form an example set which is independent of the examples previously used to create the system. Alternatively, for example, the approach of cross-validation (Https://en.wikipedia.org/wiki/Cross-validation_(statistics)) or similar approaches can also be used. A check is made on the basis of the results of the cross-validation as to whether the example-based system has achieved the quality required for validation (cross-validation). This further method step JJ should be assigned to the step

“System validation” or English “System Validation”, which is carried out in the framework of the procedure with the V-model 301.

In particular, the trained example-based subsystem is validated by means of a validation example set.

Accordingly, the training example set or a subset thereof forms a first example set, which comprises a plurality of examples. A first quality evaluation is ascertained for the first example set. A second example set is determined by applying the trained example-based subsystem (for example, the neural network). For this purpose, input values (measurement points) in the input space can be distributed randomly or systemically. For each input vector, an output vector is determined by way of the example-based subsystem.

The second example set is formed on the basis of these examples generated by the example-based subsystem. A second quality evaluation is then ascertained for this second example set. The first and second example sets are compared on the basis of the first and second quality evaluations.

Further, for example, a third example set, which forms the union set of the first and second example sets, is ascertained from the first and second example sets, and a third quality evaluation for the third example set. Further, the first quality evaluation, the second quality evaluation and the third quality evaluation are compared.

If, for example, regions are found in the space where increased local complexity occurs in the union set (on the basis of the third quality evaluation), it is possible to infer a poor generalization of the example-based subsystem. These regions are identified and measures are taken to rectify the problem. This can be achieved, for example, by changes in parameters of the neural network used (for example, correction of the number of degrees of freedom in the region of the input space with poor quality), by acquiring further examples, by changing the training parameters or by inserting regularization terms.

In a further method step KK of the procedure, the system is operated, maintained and the performance monitored.

Although the invention has been illustrated and described in detail by the preferred exemplary embodiment, it is not limited by the disclosed examples, and a person skilled in the art can derive other variations herefrom without departing from the scope of the invention.

1-31. (canceled)

32. A method for quality assurance of a system which has an example-based subsystem, the method comprising:
creating and training the example-based subsystem on a basis of collected examples that form an example set;
carrying out the quality assurance of the system on a basis of a procedure model for carrying out a development process, which represents a plan for a procedure in the quality assurance of the system; and
conducting the quality assurance of the example-based subsystem on a basis of a quality evaluation which is ascertained on a basis of the example set.

33. The method according to claim 32, wherein:
a respective example of the example set comprises an input value which lies in an input space; and
a local environment of an example in the input space is used for a decision about an application of the example-based subsystem or for controlling a development process.

34. The method according to claim 33, which comprises weighting an application of a plurality of example-based subsystems depending on a density of the examples in a local environment of the input space of an example.

35. The method according to claim 34, which comprises making a decision about a selection of the application of an example-based subsystem from a plurality of alternative example-based subsystems.

36. The method according to claim 35, which comprises deciding not to apply an example-based subsystem if a number of examples which are present in the local environment of the example is less than a predefined value.

37. The method according to claim 33, which comprises setting a process parameter which represents a trustworthiness of a competence of the example-based subsystem as a function of the local environment of the example.

38. The method according to claim 32, wherein a respective example comprises an output value which lies in an output space, and the method further comprises:
determining a local complexity evaluation (E) for a respective surrounding area, which represents a complexity of a task of the example-based system defined by the examples of the surrounding area; and
determining the local complexity evaluation by a relative position of the examples of the surrounding area with respect to each other in an input space and output space (EI).

39. The method according to claim 38, which comprises making a decision that an example-based subsystem is not applied because the complexity evaluation in the local environment of the input space is greater than a predefined value for a stipulated quality of the application of the example-based subsystem.

40. The method according to claim 38, which comprises weighting the application of a set of example sets in dependence on the local complexity in the local environment of the input space.

41. The method according to claim 33, which comprises making the decision on a basis of at least one of the following:
a given number of nearest neighbors to an example;
a number of examples that are situated at a defined standardized distance from the example under consideration;
a quality indicator in a subspace of the input space which is determined for a relevant subset of the subspaces of the input space.

42. The method according to claim 32, wherein ascertaining (C) the quality evaluation comprises:
distributing (CI) representatives in the input space; and
assigning a number of examples of the example set to the respective representative;
wherein the examples assigned to the representative are located in a surrounding area of the input space which surrounds the representative; and
wherein a local quality evaluation for the surrounding area is ascertained as a quality evaluation.

43. The method according to claim 42, wherein the quality evaluation comprises a statistical mean, and the statistical mean is determined based on:
the local environment; and/or
from the representative to which the example under consideration is assigned in accordance with a position thereof in the input space.

44. The method according to 43, which comprises ascertaining a statistical measure selected from the group consisting of a mean, a median, a minimum, and a quantile of the number as the statistical mean.

45. The method according to claim 38, wherein the complexity evaluation is an integrated quality indicator QI², and the quality indicator is determined on a basis of the following definition:
$${QI}^{2} ( P ) = \frac{1}{\vert {P}^{2} \vert} {\sum }_{{x}_{i} ∈ {P}^{2}} {( {d}_{NRE} ( {x}_{i} ) - {d}_{NRA} ( {x}_{i} ) )}^{2}$$
where:
$${d}_{NRE} ( x ) = {d}_{RE} ( x ) / \frac{{\sum }_{y ∈ {P}^{2}} {d}_{RE} ( y )}{\vert {P}^{2} \vert}$$
is a standardized distance of the represented inputs; and
$${d}_{NRA} ( x ) = {d}_{RA} ( x ) / \frac{{\sum }_{y ∈ {P}^{2}} {d}_{RA} ( y )}{\vert {P}^{2} \vert}$$
is a standardized distance of the represented outputs;
where x is the pair (x₁, x₂,) consisting of the two examples x₁ and x₂;
where x₁ and x₂ are examples from the example set P;
where P={p₁, p₁, . . . , p_{|P|}} is the set of elements of the multiset BAG P; and
where |P²| is the number of elements of the multiset BAG P.

46. The method according to claim 38, wherein the complexity evaluation is based
on a comparison of the examples of the example set with one another; and
a set division of the examples compared with one another, wherein the examples compared with one another are divided into the following sets:
$$ECS\_EE ( P ) = \{ x \vert x ∈ {P}^{2} ∧ {d}_{RE} ( x ) \leq {δ}_{in} ∧ {d}_{RA} ( x ) \leq {δ}_{out} \}$$
$$ECS\_EU ( P ) = \{ x \vert x ∈ {P}^{2} ∧ {d}_{RE} ( x ) \leq {δ}_{in} ∧ {d}_{RA} ( x ) > {δ}_{out} \}$$
$$ECS\_UE ( P ) = \{ x \vert x ∈ {P}^{2} ∧ {d}_{RE} ( x ) > {δ}_{in} ∧ {d}_{RA} ( x ) \leq {δ}_{out} \}$$
$$ECS\_UU ( P ) = \{ x \vert x ∈ {P}^{2} ∧ {d}_{RE} ( x ) > {δ}_{in} ∧ {d}_{RA} ( x ) > {δ}_{out} \}$$
where P is an example set and P² is a set of example pairs which can be formed from P
where d_{RE}(x) is a distance of the examples x₁, x₂ in the input space and d_{RA}(x) is a distance of the examples x₁, x₂ in the output space;
wherein two examples have similar input feature values if the input space distance d_{RE}(x) is less than a predefined input delta din; and
wherein two examples have similar output feature values if the output space distance d_{RA}(x) is less than a predefined output delta δₒᵤₜ.

47. The method according to claim 32, which comprises proceeding in the quality assurance of the system in accordance with a procedure with a V-model for carrying out a development process.

48. The method according to claim 47, which comprises, as a first step of the procedure, defining an example-based portion of the system (AA).

49. The method according to claim 47, which comprises, as a further step of the procedure in the quality assurance, specifying a collection of the examples (BB).

50. The method according to claim 47, which comprises, as a further step of the procedure, defining safety demands and a safe state of the system (CC).

51. The method according to claim 47, which comprises, as a further step (DD) of the procedure,
defining the quality assurance for the examples;
collecting the examples; and
carrying out an initial quality assurance of the examples.

52. The method according to claim 47, which comprises, as a further step of the procedure, defining (EE):
a modularization of an overall task to be achieved by the subsystem;
a transformation of the examples;
a representation of the examples;
an encoding of the examples; and
a network structure of an artificial neural network of the example-based subsystem.

53. The method according to claim 47, which comprises, as a further step of the procedure, implementing (FF):
modules generated during modularization, which are subnetworks of the artificial neural network;
the transformations of the examples;
the representation of the examples;
the encoding of the examples; and
the artificial neural network.

54. The method according to claim 47, which comprises, as a further step of the procedure, carrying out (GG):
a transformation of the examples;
representations of the examples;
encoding of the examples; and
training and testing the artificial neural network.

55. The method according to claim 33, which comprises:
ascertaining a protected region of the input space on a basis of the quality evaluation; and
applying an artificial neural network exclusively in the protected region.

56. The method according to claim 53, which comprises, as a further step of the procedure, integrating the modules by taking into account knowledge about a protected region (HH), wherein the knowledge is obtained on the basis of the quality evaluation.

57. The method according to claim 56, which comprises following a track of an example by monitoring neurons of the artificial neural network excited by the example.

58. The method according to claim 56, which comprises validating (JJ) the example-based subsystem on a basis of a validation example set, which comprises independent validation examples.

59. The method according to claim 47, which comprises, as a further step of the procedure:
assigning creation examples, which are acquired for the creation of the example-based subsystem, to a first example set;
assigning application examples, which are acquired in the application of the example-based subsystem, to a second example set; and
comparing a first quality evaluation, which is ascertained on a basis of the first example set, with a second quality evaluation, which is ascertained on a basis of the second example set.

60. The method according to claim 47, wherein the respective example of the example set comprises an input value which lies in an input space, and the method comprises, as a further step of the procedure:
assigning training examples which are used for training the example-based subsystem to a first example set;
assigning further examples which are generated by the example-based subsystem on a basis of input values distributed in the input space, to a second example set; and
comparing a first quality evaluation, which is ascertained on a basis of the first example set, and a second quality evaluation, which is ascertained on a basis of the second example set, with one another.

61. A computer program comprising commands which, when the program is executed by a computing unit, cause the computing unit to carry out the method according to claim 32.

62. A non-transitory computer-readable storage medium comprising commands which, when executed by a computing unit, cause the computing unit to carry out the methods according to claim 32.
